(19) United States
(12) Patent Application Publication
(10) Pub. No.: US 2012/0161950 A1
(43) Pub. Date: Jun. 28, 2012

(54) SENSORY OUTPUT APPARATUS, SYSTEM AND METHOD

(75) Inventors: Courtney Heron, Naperville, IL (US); David Gradl, Naperville, IL (US); Robert Campbell, Naperville, IL (US)

(73) Assignee: TOUCHSENSOR TECHNOLOGIES, LLC, Wheaton, IL (US)

(21) Appl. No.: 13/332,597

(22) Filed: Dec. 21, 2011

Related U.S. Application Data
(60) Provisional application No. 61/426,144, filed on Dec. 22, 2010.

(51) Int. Cl. G08B 6/00

(52) U.S. Cl. 340/407.2

(57) ABSTRACT

An output device provides sensory feedback when a user actuates a sensor associated with the output device corresponding to a particular input quantity, for example, touch or proximity by an object to a corresponding input device.

### CROSS-REFERENCE TO RELATED APPLICATIONS

This application claims priority from U.S. Provisional Patent Application 61/426,144, filed on Dec. 22, 2010, and incorporates by reference the disclosure thereof in its entirety.

### SUMMARY OF THE DISCLOSURE

This disclosure is directed to apparatus, systems and methods for providing to a user sensory output indicative of some measurable quantity, for example, position, temperature, and level, among others.

### BRIEF DESCRIPTION OF THE DRAWINGS

FIG. 1 is a block diagram of a haptic output system 10 including an input section 20 and a haptic output unit 30, the haptic output unit including a haptic output module 32, an output logic control module 34, and a haptic output signal generation module 36;

FIG. 2 is an elevation view of a vessel 48 including multiple input section sensors 22A-22F associated with the sidewall thereof and an associated output module 32;

FIG. 3 is an elevation view of vessel 48 including a float-type level sensor 50 and an associated output module 32;

FIG. 4 is a perspective view of a slide switch 20′ including multiple input section sensors 22A-22F associated with a surface thereof and an associated output module 32; and

FIG. 5 is a plan view of a weathervane 20″ including multiple input section sensors 22A-22H associated with a surface thereof and an associated output module 32.

### DETAILED DESCRIPTION OF THE ILLUSTRATED EMBODIMENTS

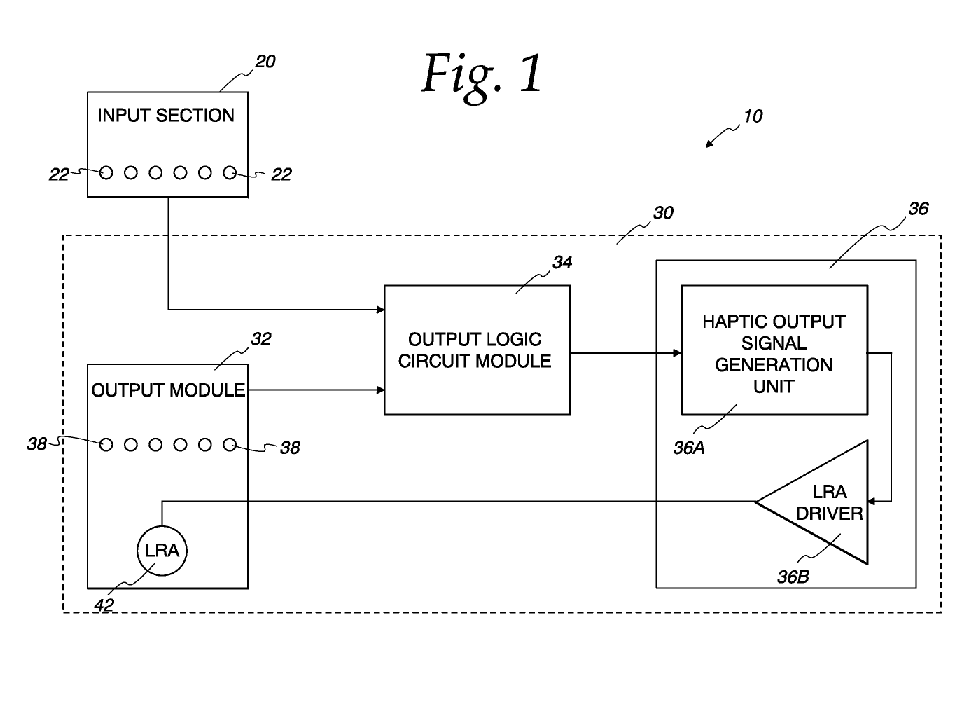

FIG. 1 is a block diagram showing an exemplary embodiment of a sensory output system in the form of haptic output system 10. Haptic output system 10 includes an input section 20 in communication with an output section 30.

Input section 20 includes six input section sensors 22 configured to detect and generate signals indicative of a measurable, scalar (or other) parameter. For example, input section sensors 22 could be configured to detect and provide signals indicative of the level of a fluid or other substance in a container, the position or length of an object, temperature, current, voltage, linear or angular speed, direction, and/or orientation, among other parameters. In other embodiments, input section 20 could include more or fewer (as few as one) than six input section sensors 22.

Output section 30 includes an output module 32, an output logic circuit module 34, and an optional haptic output signal generation module 36.

Output module 32 includes six output section sensors 38 configured to be actuated by a user's finger or other object and to generate signals indicative of whether or not they have been so actuated. In other embodiments, output module 32 could include more or fewer (as few as one) than six output section sensors 38. Typically, but not necessarily, the number of output section sensors 38 provided in output section 30 would correspond to the number of input section sensors 22 provided in input section 20.

Output module 32 also includes a haptic output device 42 in the form of a linear resonant actuator (LRA). In other embodiments, output module 32 could include more than one haptic output device 42.

Output logic circuit module 34 receives the signals from input section sensors 22 and output section sensors 38, directly or indirectly, by wired or wireless means. Output logic circuit module 34 processes these signals to determine whether the signals received from input section sensors 22 correspond to the signals received from output section sensors 38 according to specified criteria. If so, output logic circuit module 34 generates an output signal indicative of the specified criteria being met. This output signal is provided to haptic output signal generation module 36. Haptic signal generation module 36, in turn, generates and provides to haptic output device 42 a haptic waveform, thereby actuating haptic output device 42.

Output logic circuit module 34 could be configured to provide the foregoing output signal as a single pulse for each occurrence of the foregoing specified criteria being met, as plural pulses for each occurrence of the foregoing specified criteria being met, as a continuous signal having a specified duration for each occurrence of the foregoing specified criteria being met, or as a continuous signal for the duration of the foregoing specified criteria being met. Output logic circuit module 34 could be configured to provide the foregoing output signal in other manners, as well.

Output section 30 is illustrated as an integrated unit including output section sensors 38, haptic output devices 42, output logic control module 34, and optional haptic output signal generation module 36. This integrated unit could be a discrete, standalone device or it could be incorporated into a user interface panel or other structure.

Alternatively, the foregoing elements of output system 30 could be embodied as discrete components, or any of them could be integrated with one or more others of them. In such embodiments, the foregoing elements or assemblies thereof could be standalone units or they could be incorporated into one or more user interface panels or other structures. For example, haptic output module 32 including output section sensors 38 and haptic output devices 42 could be a discrete device, physically separate from output logic control module 34. Alternatively, haptic output module 32 could be incorporated into another user interface panel or other structure. Further, rather than being located together in output module 32, output section sensors 38 and haptic output devices 42 could be located in separate structures adjacent to, near to or remote from each other. Output section 30 could include other components, as well.

Input section sensors 22 could be embodied in any suitable form, as would be recognized by one skilled in the art. In some embodiments, input section sensors 22 could be embodied as one or more discrete electronic sensors, such as field effect sensors and capacitive sensors, magnetic sensors, optical sensors, inductive sensors, and trapped acoustic resonance sensors, among others, located in or on a user interface panel or other substrate. For example, input section sensors 22 could be embodied as TS-100 or TS-100PE field effect sensors marketed by TouchSensor Technologies, LLC of Wheaton, Ill. The general principle of operation of the TS-100 sensor is described in U.S. Pat. No. 6,320,282, the disclosure of which is incorporated herein by reference in its entirety. In other embodiments, input section sensors 22 could be embodied as one or more electromechanical switches, for example, membrane switches, push button switches, rotary switches, and magnetic switches, among others, located in or on a user interface panel or other substrate. In further embodiments, input section sensors 22 could take the form of one or more other sensors or switches, for example, temperature sensors, voltmeters, ammeters, ohmmeters, flow meters, and float switches, among others, arranged to obtain and transmit information regarding a corresponding variable or condition.

Output section sensors 38 similarly could be embodied in any suitable form, as would be recognized by one skilled in the art. For example, output section sensors 38 could be embodied as one or more discrete electronic sensors, such as field effect sensors and capacitive sensors, magnetic sensors, optical sensors, inductive sensors and trapped acoustic resonance sensors, among others, and/or one or more electromechanical switches, for example, membrane switches, push button switches, rotary switches, and magnetic switches, among others, located in or on a user interface panel or other substrate, as set forth above.

Haptic output device 42 is illustrated as an LRA. In other embodiments, haptic output device 42 could be embodied in other forms. For example, haptic output device 42 could be embodied as a piezoelectric material or an eccentric rotating mass, either of which could provide a vibratory output. Alternatively, haptic output device 42 could be embodied as a device configured to provide another form of sensory output, for example, audible or visual output, as would be recognized by one skilled in the art. Multiple sensory output devices of like or different types (for example, one or more LRAs, bells, buzzers, horns, lamps, LEDs, etc.) could be used in a given embodiment in order to achieve the desired type and magnitude of sensory effect.

Haptic output signal generation module 36, where provided, could be embodied as any suitable device capable of providing a signal to energize and/or drive an LRA or other haptic output device 42. For example, haptic output signal generation module 36 could be embodied as a Gemini M-16 haptic drive circuit module by Immersion Corporation. The Gemini M-16 module includes a haptic effect waveform generator 36A for generating a haptic effect waveform and an LRA driver 36B for driving one or more LRAs with the haptic effect waveform. The shape and length of the haptic effect waveform could be selected as desired, as would be understood by one skilled in the art.

Alternatively, haptic output signal generation module 36 could be embodied as an low frequency oscillator or other structure capable of generating an electrical signal sufficient to drive one or more LRAs or other haptic output devices 42. In embodiments using audible or visual output devices in lieu of LRAs, haptic output signal generation module 36 could be embodied as any structure capable of generating a steady or intermittent signal capable of driving the audible or visual output device. Alternatively, haptic output signal generation module 36 could be omitted in such embodiments and the foregoing audible or visual output device could be actuated directly by the output signal of output logic control module 34 or by other intervening circuitry, as would be understood by one skilled in the art.

Haptic output system 10 could be used in numerous applications, some of which are described in the following examples.

### EXAMPLE 1

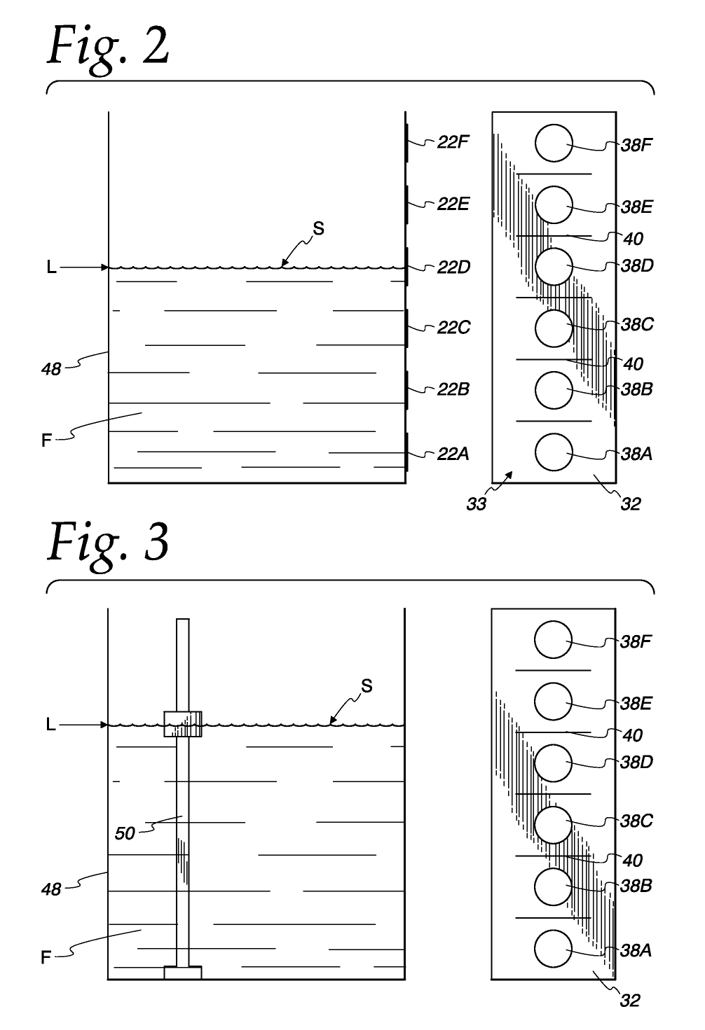

FIG. 2 illustrates an application wherein input section 20 includes six discrete input section sensors 22A-22F disposed on or in the sidewall of container 48 containing a substance that is detectable by input section sensors 22A-22F, for example, fluid F. More or fewer than six input section sensors 22 could be used in other embodiments. Input section sensors 22A-22F are configured to detect the proximity of fluid F thereto. Each of input section sensors 22A-22F outputs a first signal, for example, a high level signal, when the fluid is in proximity thereto, and outputs a second signal, for example, a low level signal, when the fluid is not in proximity thereto. In other embodiments, each of input section sensors 22A-22F could output a low level signal when the fluid is in proximity thereto and output a high level signal when the fluid is not in proximity thereto.

FIG. 2 illustrates the free surface S of fluid F at a level L corresponding to the level of input section sensor 22D and, therefore, at or above the levels of each of input section sensors 22A-22D and below the levels of each of input section sensors 22E-22F. In this state, each of input section sensors 22A-22D would output a first signal, for example, a high level signal, indicative of the proximity of fluid F thereto, and each of input section sensors 22E-22F would output a second signal, for example, a low level signal, indicative of the absence of fluid F in proximity thereto.

FIG. 2 also illustrates output module 32 in the form of a panel configured to emulate a level gauge corresponding to the height of container 48. Six output section sensors 38A-38F are arranged on a surface 33 of output module 32 in a manner that mimics the placement of input section sensors 22A-22F on container 48. Output module 32 could, but need not, be configured so that output section sensors 38A-38F are oriented vertically, further emulating a level gauge. More or fewer than six output section sensors 38 could be used in other embodiments. The number of output section sensors 38 typically would correspond to the number and relative locations of input section sensors 22 on container 48.

FIG. 2 further illustrates optional tactile structure in the form of frets 40 on surface 33 between adjacent pairs of output section sensors 38. Although optional, frets 40 can be desirable, particularly in embodiments where output section sensors 38 are realized as discrete electronic sensors located underneath a smooth surface of a user interface panel or other substrate. Frets 40 could be embodied in the form of tape strips, arrangements of bumps, or other raised (relative to the surface on which output section sensors 38 are located) structure between adjacent pairs of output section sensors 38. Alternatively, frets 40 could be embodied as depressions formed into the surface on which output section sensors 38 are located. Where provided, frets 40 could provide non-visual indication (which non-visual indication could visual elements, as well) of the relative position of a user's finger or other object with respect to the array of output section sensors 38 and/or movement from the region about one output section sensor 38 to the region about another output section sensor 38. Other tactile indicia could be provided in addition to or instead of frets 40 to further provide such non-visual indication.

The output signals of input section sensors 22A-22F and output section sensors 38A-38F are provided to output logic circuit module 34. Output logic circuit module 34 processes these signals and selectively generates an output signal causing the actuation of haptic output devices 42 (a “haptic output signal”) when the signals from input section sensors 22A-22F correspond to the signals from output section sensors 38A-38F according to specified criteria.

For example, the specified criteria could dictate that output logic circuit module 34 generate a haptic output signal only when the output section sensor 38A-38F corresponding to the uppermost of input section sensors 22A-22F detecting the proximity of fluid F in container 48 is actuated. Applying this criteria to the situation shown in FIG. 2, wherein the uppermost input section sensor detecting the proximity of fluid F is input section sensor 22D, actuation of output section sensor 38D would result in output logic circuit module 34 generating a haptic output signal, in turn causing actuation of haptic output device 42, but actuation of any of output section sensors 38A-38C and 38E-38F would not.

Alternatively, the specified criteria could dictate that output logic circuit module 34 generate a haptic output signal when any output section sensor 38A-38F corresponding to any input section sensor 22A-22F detecting the proximity of fluid F in container 48 is actuated. Applying these criteria to the situation shown in FIG. 2, actuation of any of output section sensors 38A-38D would result in output logic circuit module 34 generating a haptic output signal, in turn causing actuation of haptic output device 42, but actuation of any of output section sensors 38E-38F would not.

As discussed above, the haptic output signal could be pulsed such that haptic output device 42 is actuated in a discrete manner for each occurrence of the specified criteria being met. For example, a single haptic output signal pulse could be provided to haptic output signal generation unit 36A upon simultaneous actuation of input section sensor 22D and output section sensor 38D. A further pulse would not be generated until input section sensor 22D and output section sensor 38D were no longer simultaneously actuated and were then again simultaneously actuated. Haptic output signal generation unit 36A, in turn, would generate and provide to LRA driver 36B a single haptic effect waveform of predetermined length. LRA driver 36B would use this waveform to actuate haptic output device 42 for a length of time corresponding to the length of the haptic effect waveform.

In some embodiments, plural haptic output signal pulses could be provided serially for each occurrence of the specified criteria being met, such that haptic output signal generation unit 36A would serially generate plural haptic effect waveforms, effectively lengthening the overall duration of actuation of haptic output device 42 for each occurrence of the specified criteria being met.

In other embodiments, haptic output signal pulses could be provided serially and continuously whenever the specified criteria are met, such that haptic output signal generation unit 36A would serially and continuously generate haptic effect waveforms, effectively causing continuous actuation of haptic output device 42 so long as the specified criteria are met.

Alternatively, a continuous haptic output signal could be provided for a predetermined duration for each occurrence of the specified criteria being met. For example, the haptic output signal could be continuous for several seconds (or a greater or shorter length of time) for each occurrence of the specified criteria being met.

In other embodiments, a continuous haptic output signal could be provided for the entire duration that the specified criteria are met, effectively causing continuous actuation of haptic output device 42 for the entire duration that the specified criteria are met.

Although this example is directed to applications involving level sensing, one skilled in the art would recognize that its principles readily could be adapted to applications involving other parameters of interest, for example, position sensing. One such application could involve an automobile seat mounted on a track allowing fore and aft adjustment as would be understood be one skilled in the art. The track could include a fixed member attached to the vehicle and a movable member attached to the seat, as would be recognized by one skilled in the art. The fixed member could be provided with input section sensors 22 in the form of discrete position sensors, and the movable member could include triggering structure to actuate any or all of the input section sensors when in proximity thereto. The input section sensors could thereby provide signals to output logic control module 34 indicative of the position of the movable member relative to the fixed member, thus providing an indication of the position of the seat relative to the range of fore and aft travel available to it.

Output section sensors 38 could be provided, for example, on a panel located on the side of the seat, preferably in a linear array mimicking the bounds of travel of the seat on the track. A user could run a finger along the panel to actuate individual ones of the output position sensors 38, the outputs of which also would be provided to output logic control module 34. A haptic output device 42 could be actuated when the user actuates the output section sensor 38 corresponding to the relative position of the seat. Alternatively, haptic output device 42 could be actuated when the user actuates the output section sensor 38 corresponding to the relative position of the seat or any output section sensor 38 corresponding to a seat position fore or aft of that position.

### EXAMPLE 2

FIG. 3 illustrates an application similar to that illustrated in FIG. 2, but wherein the input section sensor is embodied as a float-type sensor 50 located in vessel 48 instead of discrete sensors 22A-22F associated with a side wall of vessel 48. Float sensor 50 preferably is adapted to provide a proportionally variable (for example, analog) output indicative of the level of the fluid in vessel 48. The output of float sensor 50 can be processed to yield a signal indicative of the level L of the free surface of fluid F in container 48, as would be understood by one skilled in the art. This processing could be performed by a processor located in input section 20 or elsewhere. For example, this processing could be performed by output logic circuit module 34. Output logic control module 34 could be configured to generate a haptic output signal only when the output section sensor 38A-38F corresponding most closely to the level L of the free surface of fluid F in container 48 is actuated. Alternatively, output logic control module 34 could be configured to generate a haptic output signal when any output section sensor 38A-38F corresponding to the level L of the free surface of fluid F or a level below level L is actuated.

Although this example is directed to application involving level sensing, one skilled in the art would recognize that its principles readily could be adapted to applications involving other parameters of interest, for example, voltage, current, speed, position, among others, by replacing float switch 50 with an appropriate sensor associated with the parameter of interest. One such application could involve provision of haptic output as an indication of remaining energy in a power source, for example, a battery for a laptop computer. Means, as would be recognized by one skilled in the art, for sensing the remaining energy could provide to output logic control module 34 a signal indicative of the remaining energy. Such means could include, without limitation, a voltmeter for determining battery voltage, an ammeter for determining current delivered by the battery to a load, and/or a means for determining the battery's internal resistance.

Output section sensors 38 could be provided, for example, on a panel located on a surface of the computer. Output section sensors 38 preferably would be arranged in an array, linear or otherwise, mimicking a charge meter. A user could run a finger along the panel to actuate individual ones of the output position sensors 38, the outputs of which also would be provided to output logic control module 34. A haptic output device 42 could be actuated when the user actuates the output section sensor 38 corresponding to the level of remaining energy in the battery or other power source. Alternatively, haptic output device 42 could be actuated when the user actuates the output section sensor 38 corresponding to the level of remaining energy or any output section sensor 38 corresponding to the level of remaining energy or any greater or lower level of remaining energy.

### EXAMPLE 3

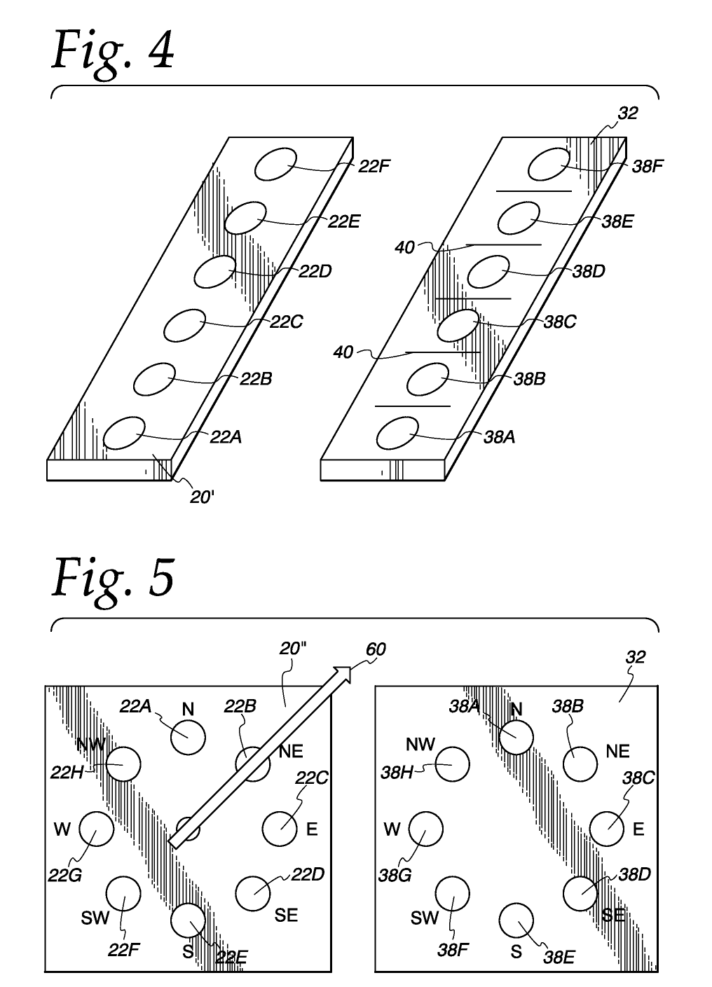

FIG. 4 illustrates an application wherein input section 20 is embodied as a slide switch 20′ including input section sensors 22A-22F. FIG. 4 also illustrates output module 32, which is similar to output module 32 described above in connection with Examples 1 and 2.

Slide switch 20′ could be used, for example, to set an output level for a controlled device, for example, a lighting unit, an audio apparatus, a motor, etc., by a user touching or otherwise actuating one of input section sensors 22A-22F corresponding to the desired level. The user's selection of an output level corresponding to a particular input section sensor 22A-22F could be stored, for example, in output logic control module 34.

Output module 32 could be used to remotely monitor the selected level by a user selectively actuating individual ones of output section sensors 38A-38F. More particularly, output logic circuit module 34 could compare the signal provided by the output section sensor 38A-38F actuated by the user to the stored input section signal and generate a haptic output signal in response to a signal from the output section sensor corresponding to the stored input section signal.

### EXAMPLE 4

FIG. 5 illustrates an application wherein input section 20 is embodied as a weathervane 20″ including pointer 60 and input section sensors 22A-22H corresponding to the compass points N, NE, E, SE, S, SW, W and NW, respectively. Pointer 60 could comprise a conductive mass or include a conductive mass disposed thereon or therein such that the conductive mass travels into and out of proximity with, and thereby selectively actuates, individual ones of input section sensors 22A-22H as pointer 60 rotates. FIG. 5 also illustrates output module 32 having output section sensors 38A-38H corresponding to the compass points N, NE, E, SE, S, SW, W and NW, respectively. The structure and operation of output module 32 otherwise is analogous to that of output module 32 described above in connection with Examples 1-3.

The principles of this application could be applied to emulate and monitor the status of a rotary switch, as would be recognized by one skilled in the art.

In other applications, output section sensors 38 could be arranged in other ways. For example, the output section sensors 38 could be arranged in semi-circular, rectangular, ovoid, curvilinear, or irregularly-shaped arrays. A three-dimensional array could be realized by locating output sections sensors 38 on a non-planar surface or multiple surfaces of a panel or other substrate.

The number, type, and arrangement of input section sensors 22 and output section sensors 38 discussed and shown in the foregoing examples and illustrations, as well as the examples and illustrations themselves are merely exemplary and are not intended to limit the scope of the invention as claimed below. Indeed, the number, type, and arrangement of input section sensors and output section sensors 38 used in a particular embodiment would depend on the application, as would be recognized by one skilled in the art.

As further described above, and as would be recognized by one skilled in the art, other forms of sensory output devices and appropriate means for actuating them could take the place of the haptic output devices and means for actuating them set forth in the foregoing description and examples. Also, the principles described in connection with a particular example, application, or embodiment herein could be applied to other examples, applications, or embodiments described herein, as would be recognized by one skilled in the art.

1. A sensory output system comprising:
an input section comprising a plurality of input section sensors;
a sensory output module comprising a plurality of output section sensors and a sensory output device;
a logic section receiving signals from said at least one input section sensor and said at least one output section sensor, said logic section providing an output signal indicative of actuation of a specific one of said plurality of input section input devices and actuation of a corresponding specific one of said output section sensors according to specified criteria.

2. The system of claim 1 wherein said sensory output device comprises a haptic output device.

3. The system of claim 2 further comprising a haptic output signal generator module receiving said output signal from said logic section and outputting a haptic waveform.

4. The system of claim 2 wherein said haptic output device comprises a linear resonant actuator.

5. The system of claim 4 further comprising a haptic output signal generator module and a linear resonant actuator driver coupled between said logic section and said linear resonant actuator.

6. The system of claim 1 wherein said plurality of input section sensors is arranged in a first predetermined arrangement.

7. The system of claim 6 wherein said plurality of output section sensors is arranged in a second predetermined arrangement corresponding to said first predetermined arrangement.

8. The system of claim 1 wherein at least one of said plurality of input section sensors and said plurality of output section sensors is adapted to detect proximity or touch.

9. The system of claim 1 wherein said sensory output device is actuated only when one of said input section sensors and a corresponding one of said output section sensors are actuated substantially simultaneously.

10. The system of claim 1 wherein said sensory output device is actuated only when a plurality of said input section sensors and a corresponding plurality of said output section sensors are actuated substantially simultaneously.

11. The system of claim 1 wherein said sensory output device is actuated only when a plurality of said input section sensors and at least one of said output section sensors are actuated substantially simultaneously, said at least one output section sensor corresponding to one of said plurality of actuated input section sensors.

12. The system of claim 1 wherein each of said plurality of input section input devices represents a scalar value.

13. The system of claim 12 wherein said plurality of input section input devices is arranged to detect level of a substance in a volume.

14. The system of claim 12 wherein said plurality of input section input devices is arranged to detect position of a stimulus.

15. The system of claim 1 wherein said output section sensors are arranged on a substrate.

16. The system of claim 15 wherein a fret is disposed on said substrate, said fret separating a first of said output section sensors from a second of said output section sensors.

17. The system of claim 16 wherein a second fret is disposed on said substrate, said second fret separating said second of said output section sensors from a third of said output section sensors.

18. The system of claim 1 wherein said output section sensors are arranged in a linear arrangement.

19. The system of claim 1 wherein said output section sensors are located in a curvilinear arrangement.

20. A sensory output system comprising:
an input section comprising an input section sensor adapted to provide a variable output signal;
a sensory output module comprising a plurality of output section sensors and a sensory output device;
a logic section receiving signals from said input section sensor and said plurality of output section sensors, said logic section providing an output signal indicative of actuation of a specific one of said plurality of output section sensors corresponding to the value of said variable output signal of said input section sensor.

21. A method for providing sensory output, comprising the steps of:
sensing a parameter;
providing a plurality of sensors, one or more of said sensors corresponding to the sensed parameter;
detecting a stimulus proximate ones of said plurality of sensors;
providing a sensory output in response to detection of a stimulus of said one or more of said sensors corresponding to the sensed parameter.
